(19) United States
(12) Patent Application Publication
(10) Pub. No.: US 2023/0188655 A1
(43) Pub. Date: Jun. 15, 2023

(54) PRINTER MONITORING SYSTEM, PRINTER MONITORING METHOD, AND PRINTER MONITORING PROGRAM

(71) Applicant: SEIKO EPSON CORPORATION, Tokyo (JP)

(72) Inventor: Yasuaki MIYADOME, Sapporo-shi (JP)

(21) Appl. No.: 18/062,904

(22) Filed: Dec. 7, 2022

(30) Foreign Application Priority Data
Dec. 9, 2021 (JP) 2021-199909

(51) Int. Cl. H04N 1/00; H04N 1/32

(52) U.S. Cl. CPC H04N 1/00477; H04N 1/00419; H04N 1/00244; H04N 1/32662; H04N 1/32635; H04N 1/00042; H04N 1/00079

(57) ABSTRACT

A printer monitoring system includes: a server configured to collect event information indicating an event that occurs in a printer; and a mobile device configured to execute a display application that causes a display to display a related screen including the event information. The server generates link information for directly transitioning a screen displayed by the display application to the related screen corresponding to the event information, and transmits the event information received from the printer and the link information to the mobile device. The mobile device displays the event that occurs in the printer on the display in a selectable manner, and causes a screen displayed by the display application to be transitioned to the related screen indicated by the link information when the event is selected.

The present application is based on, and claims priority from JP Application Serial Number 2021-199909, filed Dec. 9, 2021, the disclosure of which is hereby incorporated by reference herein in its entirety.

### BACKGROUND

### 1. Technical Field

The present disclosure relates to a printer monitoring system, a printer monitoring method, and a printer monitoring program.

### 2. Related Art

In related art, a technique for monitoring an operating state of a printer is known. For example, JP-A-2019-28757 discloses a technique of collecting operation information from a printer via a network and transmitting the operation information to a terminal device via the network. According to the configuration described above, the terminal device can display the operation information of the printer.

There has been a demand for easy access to information related to a printer.

### SUMMARY

A printer monitoring system includes: a server configured to collect event information indicating an event that occurs in a printer; and a mobile device configured to execute a display application that causes a display to display a related screen including the event information. The server includes: a generation unit configured to generate link information for directly transitioning a screen displayed by the display application to the related screen corresponding to the event information; and a communication unit configured to transmit the event information received from the printer and the link information to the mobile device. The mobile device includes a transition unit configured to display the event that occurs in the printer on the display in a selectable manner, and cause a screen displayed by the display application to be transitioned to the related screen indicated by the link information when the event is selected.

A printer monitoring method is executed by a server configured to collect event information indicating an event that occurs in a printer, and a mobile device configured to execute a display application that causes a display to display a related screen including the event information. The server executes a generation step of generating link information for directly transitioning a screen displayed by the display application to the related screen corresponding to the event information, and a communication step of transmitting the event information received from the printer and the link information to the mobile device. The mobile device executes a transition step of displaying the event that occurs in the printer on the display in a selectable manner, and causing a screen displayed by the display application to be transitioned to the related screen indicated by the link information when the event is selected.

A non-transitory computer-readable storage medium stores a printer monitoring program, and the printer monitoring program causes: a server configured to collect event information indicating an event that occurs in a printer to function as a generation unit configured to generate link information for directly transitioning a screen displayed by a display application to a related screen corresponding to the event information, and as a communication unit configured to transmit the event information received from the printer and the link information to a mobile device; and the mobile device configured to execute the display application for displaying the related screen including the event information on a display to function as a transition unit configured to display the event that occurs in the printer on the display in a selectable manner, and cause a screen displayed by the display application to be transitioned to the related screen indicated by the link information when the event is selected.

### BRIEF DESCRIPTION OF THE DRAWINGS

FIG. 1 is a diagram schematically showing an example of a printer monitoring system.

FIG. 2 is a block diagram showing a configuration of a server.

FIG. 3 is a diagram showing an example of request information.

FIG. 4 is a diagram showing an example of request allocation information.

FIG. 5 is a diagram showing an example of printer status information.

FIG. 6 is a diagram showing an example of event information.

FIG. 7 is a diagram showing an example of a notification information DB.

FIG. 8 is a block diagram showing a configuration of a mobile device.

FIG. 9 is a diagram showing an example of a Production screen.

FIG. 10 is a diagram showing an example of a Printers screen.

FIG. 11 is a diagram showing an example of a screen for displaying details of a request.

FIG. 12 is a diagram showing an example of a screen for displaying details of a printer.

FIG. 13 is a diagram showing an example of a pop-up screen.

FIG. 14 is a block diagram showing a configuration of the printer.

FIG. 15 is a flowchart of a process in the printer.

FIG. 16 is a flowchart of a process in the server.

FIG. 17 is a diagram showing an example of information to be transmitted to the mobile device.

FIG. 18 is a diagram showing an example of the information to be transmitted to the mobile device.

FIG. 19 is a flowchart of a process in the mobile device.

FIG. 20 is a diagram showing an example of the pop-up screen.

### DESCRIPTION OF EXEMPLARY EMBODIMENTS

Here, embodiments of the present disclosure will be described in the following order.

### (1) System Configuration:

### (1-1) Server Configuration:

### (1-2) Mobile Device Configuration:

### (1-3) Printer Configuration:

### (2) Printer Monitoring Process:

### (2-1) Process in Printer:

### (2-2) Process in Server:

### (2-3) Process in Mobile Device:

### (3) Other Embodiments:

### (1) System Configuration:

FIG. 1 is a diagram schematically showing an example of a system including a printer monitoring system according to an embodiment of the present disclosure. A printer monitoring system 1 includes a server 10 and a mobile device 20. The server 10 is coupled to a plurality of printers 30. In the present embodiment, the number of shown devices is an example, and the number is not limited. For example, the number of printers 30 represented by a plurality of printers is not limited to the number shown in FIG. 1, and the mobile device 20 or the like represented by one mobile device may be a plurality of mobile devices 20. These devices can communicate with each other via a network. A form of the network may be various, and the network may be a local network, or devices located at physically distant positions may communicate with each other via the Internet or the like. In the example shown in FIG. 1, the server 10 and the printer 30 are coupled in a wired manner, and the server 10 and the mobile device 20 are coupled in a wireless manner.

In the present embodiment, an administrator of the server 10 receives print requests from a plurality of clients, and causes the plurality of printers 30 to print a printed matter in order to deliver the requested printed matter by a delivery date. In order to print the printed matter, a print plan of the printed matter is formulated in each of the plurality of printers 30, and each printer 30 operates in accordance with the print plan. In the present embodiment, the server 10 can collect printing progress in the printer 30, a status of the printer 30, and the like. A user of the mobile device 20 can also cause a display of the mobile device 20 to display the printing progress in the printer 30, the status of the printer 30, and the like. Further, in the present embodiment, when an event determined in advance as a notification target, such as an occurrence of an error or step progress, occurs in an operation process of each printer 30, an occurrence of the event is notified from the server 10 to the mobile device 20.

Hereinafter, configurations of the devices of the printer monitoring system 1 capable of performing such display will be described.

### (1-1) Server Configuration:

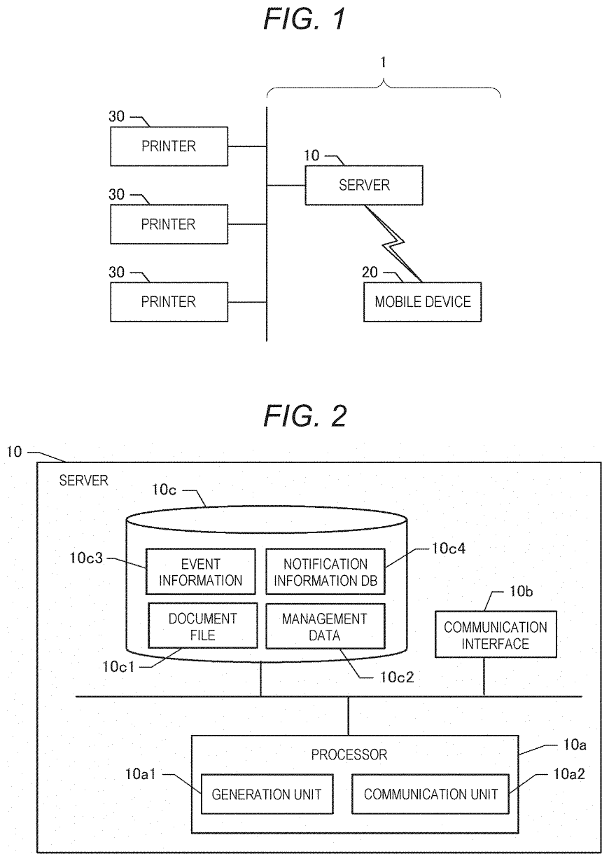

FIG. 2 is a block diagram showing a configuration of the server 10. The server 10 includes a processor 10a, a communication interface 10b, and a nonvolatile memory 10c. The processor 10a includes a CPU, a ROM, a RAM, and the like (not shown), and can execute various programs recorded in the nonvolatile memory 10c to control each unit of the server 10 and each device coupled to the network. The processor 10a may be formed of a single chip, a plurality of chips, or a SoC together with various functional blocks that operate the printer. For example, an ASIC may be employed instead of the CPU, or the CPU and the ASIC may cooperate with each other. In the present embodiment, the mobile device 20 and the printer 30 include processors, and the processors can be implemented in various modes similarly to the processor 10a.

The communication interface 10b is a device for communicating with an external device in accordance with various types of wired or wireless communication protocols. The server 10 can communicate with other devices via the communication interface 10b. The communication interface 10b may include an interface for communicating with various types of removable memories attached to the server 10.

Various types of information are stored in the nonvolatile memory 10c of the server 10. In the present embodiment, a document file 10c1, management data 10c2, event information 10c3, and a notification information DB 10c4 may be included. The document file 10cl is a file including data indicating contents to be printed on a print medium, and a pdf file or the like may be the document file 10c1.

The management data 10c2 is data for managing a step in which the plurality of printers 30 execute print requests requested by a plurality of clients. A format of the management data 10c2 is not limited, but in the present embodiment, request information, request allocation information, and printer status information are included.

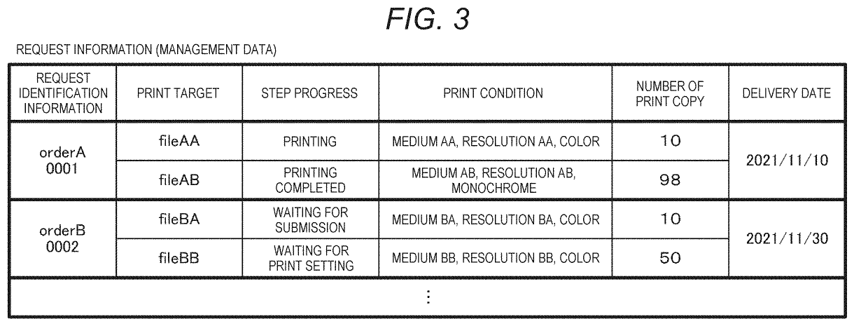

FIG. 3 shows an example of the request information. The request information is information indicating contents of printing requested by the clients, and includes request identification information, a print target, step progress, a print condition, the number of print copies, and a delivery date in the present embodiment. The request identification information is information for identifying a request from a client, and is identified by a name and a number. Hereinafter, the name as the request identification information is referred to as an order name, and the number as the request identification information is also referred to as an order number. The print target is a file name indicating a requested file to be printed. One request may include a plurality of print targets. The step progress is information indicating which step is a current step among steps determined in advance for completing the printing of each print target. In the present embodiment, the steps includes steps of waiting for submission, waiting for print setting, printing, and printing completed.

The waiting for submission is a step performed in a state where a file as the print target is not recorded as the document file 10c1, and is, for example, a step of waiting for submission when the file as the print target is not received from the client and is not recorded in the nonvolatile memory 10c or when the file as the print target is further corrected.

The waiting for print setting is a step of performing setting necessary for performing printing of each print target. When the setting is performed or it is checked that the printing step may be started with a default setting, the step of print setting ends. In the present embodiment, it is assumed that the print setting is performed in accordance with a print condition of the request information, but it is needless to say that a request from a client does not include detailed information such as the print condition, and contents of the print setting may be determined by an operator himself/herself. In any case, when the print setting for performing printing for each request is not determined, the step of waiting for print setting is performed. The printing is a step from the completion of the print setting to the completion of the printing by the printer 30. When printing of the requested number of print copies is completed, the step is the printing completed.

The print condition is a condition necessary for implementing the requested printing, and in the example shown in FIG. 3, a type of medium (medium AA or the like), a resolution (resolution AA or the like), and a color (color or monochrome) to be used are defined as the print condition. The number of print copies is the number of copies requested to be printed, and is defined for each print target. The delivery date is a date by which all of the requested printed matter should be delivered.

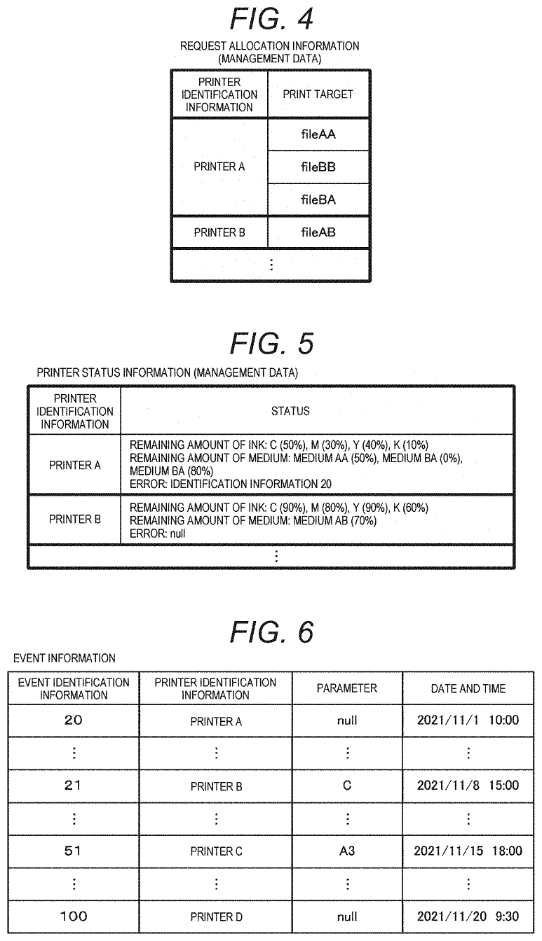

FIG. 4 shows an example of the request allocation information. The request allocation information is information indicating the print targets to be printed by each of the plurality of printers 30 and a printing order. That is, the printers 30 that print the print targets requested by the clients are automatically or artificially determined, and the printing order is also determined. The file names of the print targets and the printing order thereof are associated with printer identification information (printer A or the like) for identifying each printer 30, and are defined as the request allocation information. In the example shown in FIG. 4, fileAA, fileBB, and fileBA as the print targets are associated with the printer A so as to be printed in this order.

FIG. 5 shows an example of the printer status information. The printer status information is information indicating status of each of the plurality of printers 30, and is defined by associating the printer identification information with the information indicating the status. In the present embodiment, the status is indicated by item values for each item that can vary in an operation process of the printer 30, and includes, for example, a remaining amount of ink for each color (C: cyan, M: magenta, Y: yellow, K: black, and the like) of ink used in the printer 30 and a remaining amount of medium for each medium that can be accumulated in the printer 30. When an error occurs in the printer 30, identification information of the error is included in the printer status information. FIG. 5 shows an example in which an error of identification information 20 occurs in the printer A. In the present embodiment, the error includes an event in which printing cannot be executed and an event in which printing can be executed, but the latter event may be distinguished by being referred to as a warning or the like.

The event information 10c3 is information indicating an event that occurs in the printer. In the present embodiment, when an event in which various types of information recorded in the management data 10c2 are changed occurs in the printer 30, event information indicating a content of the event is transmitted from the printer 30 to the server 10. The processor 10a of the server 10 collects the event information and records the event information as the event information 10c3. Further, the processor 10a of the server 10 updates the management data 10c2 based on the event information.

FIG. 6 shows an example of the event information 10c3. The event information includes event identification information, the printer identification information, parameters, and date and time. The event identification information is identification information corresponding to an event that occurs in the printer 30. In the present embodiment, the event identification information is identification information indicating a type of the event that occurs, and the printer identification information indicating the printer in which the event occurs is associated with the event identification information. The parameter is information indicating the content of the event that occurs, and information indicating the content is defined instead of null when the content of the event is insufficiently identified only by the event identification information. For example, event identification information 21 indicates an error of a shortage of the remaining amount of ink in the printer 30, but whether the remaining amount of ink is insufficient is identified for each color of ink, and thus a color of ink is a parameter. For example, in a printer B shown in FIG. 6, it is identified by the parameter that C ink is insufficient. Event identification information 51 indicates an error in which the remaining amount of medium is insufficient, and in a printer C shown in FIG. 6, it is identified by the parameter that a remaining amount of A3 size medium is insufficient. The event identification information 20 indicates an error in which an ink cartridge cover provided in a carriage of the printer 30 is open. Since the content of the event is sufficiently identified only by the event identification information, the parameter of the event is null.

The event described as the event information is not limited to the error that occurs in the printer 30, and may be various types of events in which various types of information recorded in the management data 10c2 are changed. For example, a fact that an error is resolved is also an event. In addition, when the step progress included in the request information indicating the request from the client changes, the change may be identified as an event. Specifically, when the step changes from printing to printing completed since the printing in the printer 30 is completed, event information indicating the completion of the printing may be transmitted from the printer 30 to the server 10. Event identification information 100 in FIG. 6 is identification information indicating an event in which the step changes from waiting for print setting to printing.

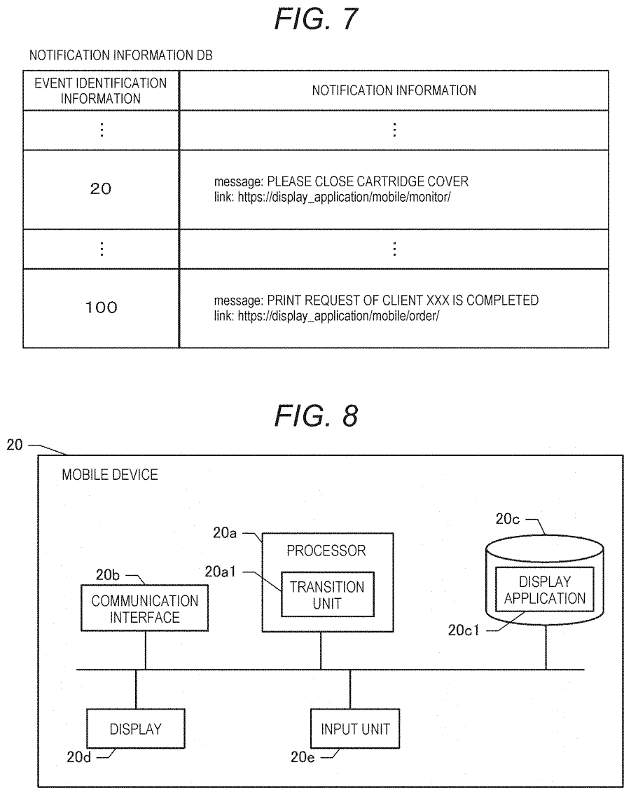

The notification information DB 10c4 is a database for identifying information to be notified to the user of the mobile device 20 when an event occurs. In the present embodiment, the information to be notified includes link information and a notification message. FIG. 7 shows an example of the notification information DB 10c4. Since the link information and the notification message may be different for each type of event, in the present embodiment, the link information is associated with the event identification information. The notification message (message shown in FIG. 7) indicates a text displayed when the user of the mobile device 20 is notified of an occurrence of an event.

The mobile device 20 according to the present embodiment is capable of executing a display application, as will be described later. The display application is an application program that causes various types of screens to be displayed on the display of the mobile device 20 and causes various types of information included in the management data 10c2 to be displayed on the respective screens. The user of the mobile device 20 can operate a user interface to cause transition of a plurality of screens prepared in advance in the display application. Therefore, by operating the user interface, the user can cause a screen for displaying desired information to be displayed and know the desired information included in the screen.

Further, in the present embodiment, the display application can receive a specification of a screen to be displayed by the display application using the link information written in a URL format. The link information (link shown in FIG. 7) included in the notification information DB 10c4 is a part of the link information for directly transitioning the screen displayed by the display application to a related screen corresponding to the event information. In the present embodiment, a configuration is adopted in which the link information is completed by adding the printer identification information, the request identification information, and the like to the link information shown in FIG. 7.

An event such as an error occurs in each individual printer 30. Therefore, in the present embodiment, event information of an event that occurs in the identified printer 30 can be displayed on a related screen for the identified printer 30. In addition, an event such as the step progress occurs in each individual request. Therefore, in the present embodiment, when an event that occurs in the printer 30 is an event related to an individual request, event information can be displayed on a related screen for the request.

Further, in the present embodiment, information to be transmitted is different for each related screen depending on contents, and the related screen to be displayed is different depending on the event that occurs. Therefore, in the present embodiment, it is possible to display the event information on the related screen corresponding to the event. As described above, in the present embodiment, the screen displayed on the display of the mobile device 20 is a screen corresponding to an event, and each screen may be a screen for the individual printer 30 or a screen for an individual request.

In the present embodiment, a related screen for each event can be specified by the link information including the event identification information. Further, a related screen for each printer 30 can be specified by link information including the printer identification information, and a related screen for each request can be specified by link information including the request identification information.

Specifically, in the present embodiment, common link information in a plurality of related screens is recorded as the link information shown in FIG. 7, and the link information is completed by adding the event identification information or the like to the common link information. In the notification information DB 10c4, the common link information is associated with the event identification information. For example, in the example shown in FIG. 7, a part of the link information for directly transitioning to a screen for displaying the event information related to the event of the event identification information 20 (an error in which the cartridge cover is open) is (https://display application/mobile/monitor/). When the event identification information 20 and the printer identification information of the printer 30 in which the event occurs are added to the link information, the added link information becomes link information of a related screen indicating that the event occurs in the printer 30.

The link information recorded in the notification information DB 10c4 is a part of the link information for directly transitioning to a related screen of an event when the event occurs with respect to the specific printer 30 or a specific request, and also functions as link information for directly transitioning to another related screen. For example, the link information https://display application/mobile/monitor/shown in FIG. 7 enables direct transition to a related screen on which a list of the printers 30 is displayed.

The description will return to FIG. 2. When a program (not shown) recorded in the nonvolatile memory 10c is started, the processor 10a executes a function of collecting the event information indicating an event that occurs in the printer 30. Further, the processor 10a transmits the event information, the management data 10c2, and the like to the mobile device 20 in response to a request from the mobile device 20, and causes the display of the mobile device 20 to display various types of information. The user of the mobile device 20 operates the user interface to cause the transition of the plurality of screens prepared in advance in the display application, and can grasp desired information such as the event information and the management data 10c2.

On the other hand, in the present embodiment, when an event occurs, the user of the mobile device 20 can cause direct transition to a related screen that displays information related to the event that occurs without going through the transition of the plurality of screens. In order to implement such direct transition, the processor 10a functions as a generation unit 10a1 and a communication unit 10a2 by a program (not shown). The generation unit 10a1 has a function of generating the link information for directly transitioning the screen displayed by the display application to the related screen corresponding to the event information. That is, the generation unit 10a1 refers to the event information 10c3 and identifies the event identification information of the event that occurs. In addition, the generation unit 10a1 refers to the notification information DB 10c4 and identifies the link information corresponding to the event and a notification message based on the event identification information. The generation unit 10a1 further adds information to the link information to complete the link information indicating the related screen corresponding to the event identification information. The information necessary for completing the link information is determined in advance for each event, and the generation unit 10a1 identifies the necessary information based on the management data 10c2, the event information 10c3, and the notification information DB 10c4. The addition of the information necessary for completing the link information will be described in detail later.

The communication unit 10a2 has a function of transmitting the event information received from the printer and the link information to the mobile device. In the present embodiment, when an event occurs, the communication unit 10a2 transmits information indicating the occurrence of the event to the mobile device 20. The information indicating the occurrence of the event includes the link information corresponding to the event that are generated by the generation unit 10a1 and the notification message. When the display of the related screen indicated by the link information is selected by the user, the transmission of the event information or the like for displaying the related screen is requested from the mobile device 20. In response to the request, the communication unit 10a2 transmits the event information to the mobile device 20 and cause the related screen to display the event information.

In the above configuration, since the event information is identified by the link information, as long as the related screen is displayed on the mobile device 20 based on the link information, the user can cause the related screen to display without a plurality of times of screen transition operations and visually recognize the event information. Therefore, the user can easily visually recognize the event information related to the event that occurs in each of the plurality of printers 30.

### (1-2) Mobile Device Configuration:

FIG. 8 is a block diagram showing a configuration of the mobile device 20. The mobile device 20 includes a processor 20a, a communication interface 20b, a nonvolatile memory 20c, a display 20d, and an input unit 20e. The processor 20a includes a CPU, a ROM, a RAM, and the like (not shown), and can execute various programs recorded in the nonvolatile memory 20c to control each unit of the mobile device 20.

The communication interface 20b is a device for communicating with an external device in accordance with various types of wireless communication protocols. The mobile device 20 can communicate with the server 10 via the communication interface 20b. The communication interface 20b may include an interface for communicating with various types of removable memories attached to the mobile device 20. Various types of data and various types of programs are recorded in the nonvolatile memory 20c of the mobile device 20. In the present embodiment, the program includes a display application 20c1 and an operating system (not shown).

The display 20d is a display device that displays any image. The input unit 20e is a device through which the user performs an input operation, and includes a button, a touch panel, and the like. The user can input an intention of the user by operating the input unit 20e while visually recognizing images and characters displayed on the display 20d.

The display application 20c1 causes the processor 20a to execute a function of causing a related screen including the event information to be displayed on the display. Specifically, the display application 20c1 can cause the display 20d to display each of a plurality of related screens including the event information. The user operates the input unit 20e to transition the related screen and can visually recognize information such as the event information displayed on a desired related screen.

In the present embodiment, the related screen has a hierarchical structure in which an upper layer screen can be transitioned to a lower layer screen. That is, a hierarchical upper relationship is defined for each of the plurality of related screens, and in response to an operation on an icon in a certain related screen, transition to a lower layer of the related screen can be performed. In addition, in response to an operation on an icon in a certain related screen, transition to an upper layer of the related screen can be performed. As a matter of course, transition can be performed by a method different from the transition between the upper layer and the lower layer, and in the present embodiment, transition between the same layers in an uppermost layer can also be performed.

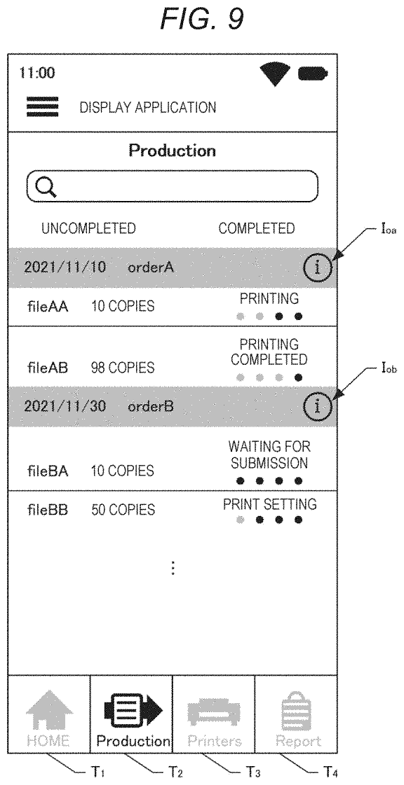

A mode of the related screen provided in each layer is not limited, and in the present embodiment, a HOME screen, a Production screen, a Printers screen, and a Report screen are prepared as uppermost layer screens. FIG. 9 is a diagram showing an example of the Production screen. The Production screen is a screen for displaying information related to requests, and a list of the requests is displayed. FIG. 9 shows an example in which a file as the print target, the number of print copies, and the step progress are displayed for each of requests whose request identification information is orderA and orderB.

When the Production screen is displayed, the processor 20a requests the server 10 to transmit the management data 10c2. The processor 20a draws a background of the screen using screen data for displaying the Production screen. The processor 20a then generates texts and icons indicating contents of requests based on the request information in the management data 10c2, and causes the display 20d to display the texts and icons side by side. As a result, the Production screen as shown in FIG. 9 is displayed. In the example shown in FIG. 9, a completed step is indicated by a gray circle, and an uncompleted step is indicated by a black circle. In a state in which various types of screens such as the Production screen are displayed, the user can cause the screen to transition by operating the input unit 20e. For example, tabs T₁ to T₄ for selecting the uppermost layer screens are provided on a lower portion of the Production screen. When the user taps each of the tabs T₁, T₃, and T₄, the processor 20a causes the HOME screen, the Printers screen, and the Report screen to be respectively displayed by the function of the display application 20c1.

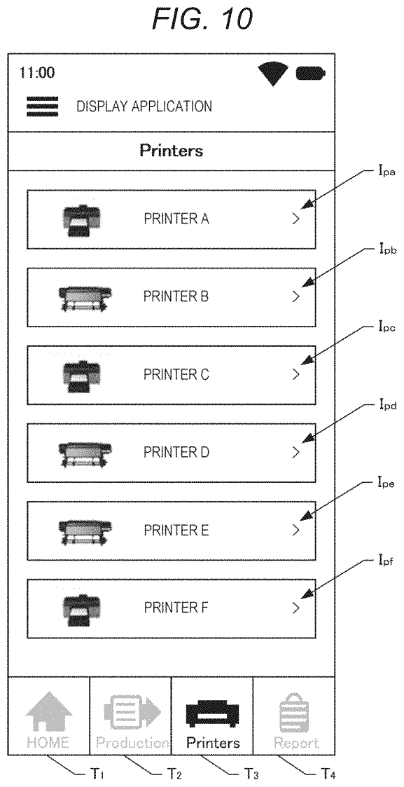

FIG. 10 is a diagram showing an example of the Printers screen. The Printers screen is a screen for displaying information related to the printers 30, and a list of the printers 30 is displayed. FIG. 10 shows an example in which icons indicating the printers 30 and the printer identification information are displayed for the respective printers 30 whose printer identification information is printer A to printer F. When the Printers screen is displayed, the processor 20a requests the server 10 to transmit the management data 10c2. The processor 20a draws a background of the screen using screen data for displaying the Printers screen. The processor 20a then generates the printer identification information and icons for the respective printers 30 based on the printer status information in the management data 10c2, and causes the display 20d to display the texts and icons side by side. As a result, the Printers screen as shown in FIG. 10 is displayed.

The HOME screen is a screen that is first displayed when the display application 20c1 is started, and the Report screen is a screen for displaying statistical information such as operating status of the plurality of printers 30. These uppermost layer screens include icons each for transitioning the screen to a lower layer. For example, icons I^{oa}, I_{ob} shown in FIG. 9 are icons each for transitioning to a screen for displaying detailed information for each request.

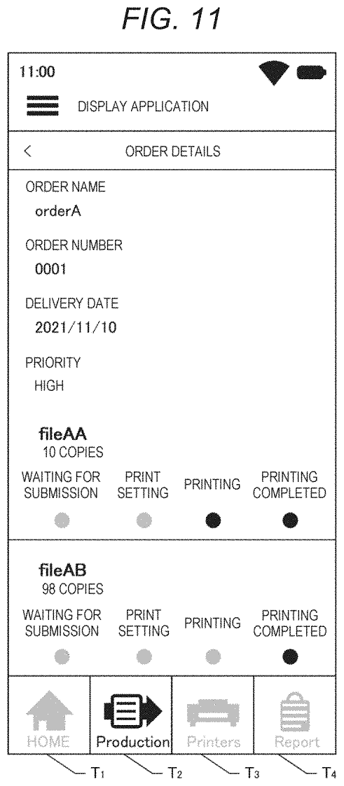

FIG. 11 shows a screen displayed when the user taps the icon Iₒₐ. When the detailed information for each request is displayed, the processor 20a requests the server 10 to transmit the management data 10c2. The processor 20a draws a background of the screen using screen data for displaying a detailed screen. The background includes texts indicating display items, for example, texts such as an order name or an order number. The processor 20a generates texts and icons indicating contents of the items based on the request information in the management data 10c2, and causes the texts indicating the contents of the items to be displayed below the respective items. For example, in FIG. 11, an order A of the request identification information is displayed as the order name, and 0001 of the order number is displayed as the order number. In addition, a lower portion of the screen includes information indicating the step progress for each print target. In the example shown in FIG. 11, the completed step is indicated by the gray circle, and the uncompleted step is indicated by the black circle.

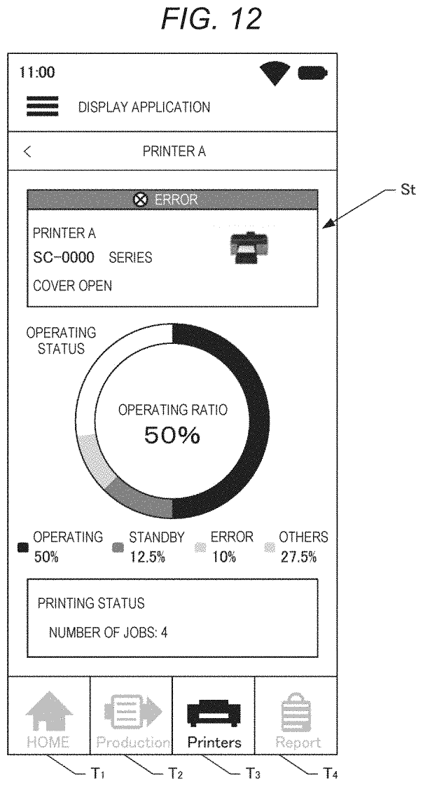

On the other hand, icons Iₚₐ, I_{pb}, I_{pc}, I_{pd}, Iₚₑ, I_{pf} shown in FIG. 10 are icons each for transitioning to a screen for displaying detailed information of each printer 30. FIG. 12 shows a detailed screen of the printer A displayed when the user taps the icon Iₚₐ. When the detailed information of the printer is displayed, the processor 20a requests the server 10 to transmit the management data 10c2 and the event information 10c3. The processor 20a draws a background of the screen using screen data for displaying a detailed screen. The background includes texts and icons indicating display items. Further, the processor 20a acquires statistics of processes executed by the printer 30 as a display target based on the request information, the request allocation information in the management data 10c2, and the event information 10c3.

The statistics may be acquired in various types of modes, and in the present embodiment, the processor 20a totals a time during which the printer 30 to be displayed operates, a time during which the printer 30 as the display target is on standby, a time during which the printer 30 as the display target cannot print due to an error, and times other than these (for example, a time during which the printer 30 to be displayed is not coupled to the network, a time during which the printer 30 to be displayed is powered off, or the like). The processor 20a then acquires a ratio of each time to a total time (from a default totalization start time to a current time) in terms of percentage, and acquires statistics of the operating status. Further, the processor 20a identifies, as the number of jobs, the number of print targets for which the steps are not completed among the print targets allocated to the printer 30 as the display target. The processor 20a then generates texts and icons (graphs, labels, and the like) indicating these pieces of information, and causes these pieces of information to be displayed. For example, in FIG. 12, the statistics of the operating status are displayed in a pie chart, and the number of jobs is displayed as a printing status.

In the present embodiment, the processor 20a further causes a status of the printer 30 as the display target to be displayed. For this purpose, the processor 20a refers to the printer status information in the management data 10c2, and identifies the status of the printer 30. The processor 20a then causes the status of the printer 30 to be displayed in a status display box St on the screen. The status as the display target may be various types of status. In the example shown in FIG. 12, a status indicating whether the printing can be performed, a content of an error, and the printer identification information are displayed in the status display box St. As the status indicating whether the printing can be performed, for example, a situation such as an error, printing, or standby is assumed, and the example shown in FIG. 12 indicates that the status of the printer A is the error. The status display box St indicates that a content of the error is cover open (the cartridge cover is open).

In the present embodiment, the user can cause the screen to transition by operating the input unit 20e. In addition, when the user wants to check information on a screen in the lower layer, such as details of the printer 30, the user can cause transition to a screen for displaying desired information by repeatedly operating the input unit 20e. In the present embodiment, in response to an operation performed on an icon in a certain screen, the screen is configured to be capable of transitioning to a screen indicated by the icon, and the screen has the hierarchical structure.

These screens can be specified by the link information written in the URL format as described above. For example, the above https://display application/mobile/shown in FIG. 7 indicates the display application 20c1 executed by the mobile device 20. Further, https://display application/mobile/monitor/shown in FIG. 7 shows the Printers screen shown in FIG. 10. In the Printers screen shown in FIG. 10, by tapping the icon Iₚₐ or the like, the screen can be transitioned to a lower layer screen, that is, the detailed screen of the individual printer 30 shown in FIG. 12. For this reason, in the present embodiment, the lower layer screen can be specified by adding information to the link information. For example, when the event identification information 20 and the printer A as the printer identification information are added to generate link information, that is https://display application/mobile/monitor/printer A&20, the link information becomes link information for specifying the screen shown in FIG. 12.

The URL https://display application/mobile/order/shown in FIG. 7 shows the Production screen shown in FIG. 9. In the Production screen shown in FIG. 9, by tapping the icon boa or the like, the screen can be transitioned to a lower layer screen, that is, the detailed screen of the individual request shown in FIG. 11. Further, with respect to link information for specifying the Production screen, when the event identification information 100 and the order A as the request identification information are added to generate link information, that is https://display application/mobile/order/orderA&100, the link information becomes link information for specifying the screen shown in FIG. 11.

The display application 20c1 causes the processor 20a to execute a process of identifying a screen to be displayed by specifying the link information and causing the display 20d to display the identified screen. In the present embodiment, direct transition of a screen according to an event notification is implemented by using a screen transition method based on such link information. That is, in the present embodiment, when an event occurs in the printer 30, direct transition to a related screen related to the event that occurs can be performed by a single operation by the user.

In the present embodiment, the processor 20a uses a notification function of an operating system to implement the direct transition to the related screen. In order to implement the direct transition, the processor 20a functions as a transition unit 20a1 by the operating system and the display application 20c1. When the transition unit 20a1 receives a notification from an external device via the communication interface 20b, the transition unit 20a1 executes various types of notifications to the user using a pop-up screen.

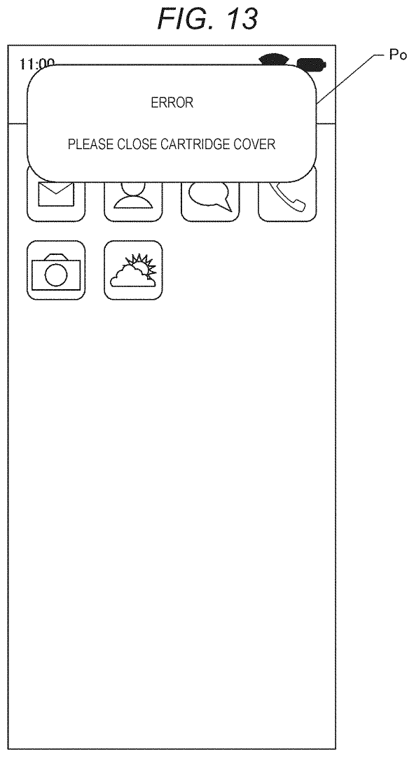

When the notification is executed, the server 10 in the present embodiment transmits information including the link information and the notification message as shown in FIG. 7. When the transition unit 20a1 acquires the information, the transition unit 20a1 causes a pop-up screen Po as shown in FIG. 13 to be displayed. In the present embodiment, the pop-up screen Po is displayed in preference to a screen displayed by any application software. In the present embodiment, in the pop-up screen Po, a notification message transmitted from the server 10 is displayed in text together with a text indicating an occurrence of an error. When the pop-up screen Po is displayed as described above, the user can recognize the occurrence of the event. Information displayed on the pop-up screen Po is not limited to the information shown in FIG. 13, and various types of information related to the event may be displayed. In addition, when a plurality of events occur, notifications related to the plurality of events may be displayed on the display 20d.

The pop-up screen Po indicates an occurrence of an event, and the event can be selected. That is, when the user taps the pop-up screen Po, the transition unit 20a1 regards the pop-up screen Po as being selected. When a notification non-selected operation, for example, a tap on a portion other than the pop-up screen Po, or a swipe on a portion including the pop-up screen Po, is performed, the transition unit 20a1 regards that the pop-up screen Po is not selected.

When the pop-up screen Po is selected, that is, when the event is selected, the transition unit 20a1 transitions the screen displayed by the display application 20c1 to the related screen indicated by the link information. Specifically, the transition unit 20a1 acquires the link information transmitted from the server 10 together with the notification message of the selected pop-up screen Po. Then, the transition unit 20a1 transfers the link information to the display application 20c1 and gives a screen display instruction. When the display application 20c1 is not started, the transition unit 20a1 transfers the link information and gives the screen display instruction after the display application 20c1 is started. As a result, by the function of the display application 20c1, the processor 20a displays the related screen indicated by the link information on the display 20d.

According to the above process, the user can cause the related screen including the event information of the event to be displayed simply by selecting the pop-up screen Po which is the notification indicating the occurrence of the event. That is, the user does not need to perform a plurality of times of screen transition operations, and can cause direct transition to the related screen including the event information simply by one action on the pop-up screen Po. Therefore, according to the present embodiment, the user can easily access the information related to the printer 30.

### (1-3) Printer Configuration:

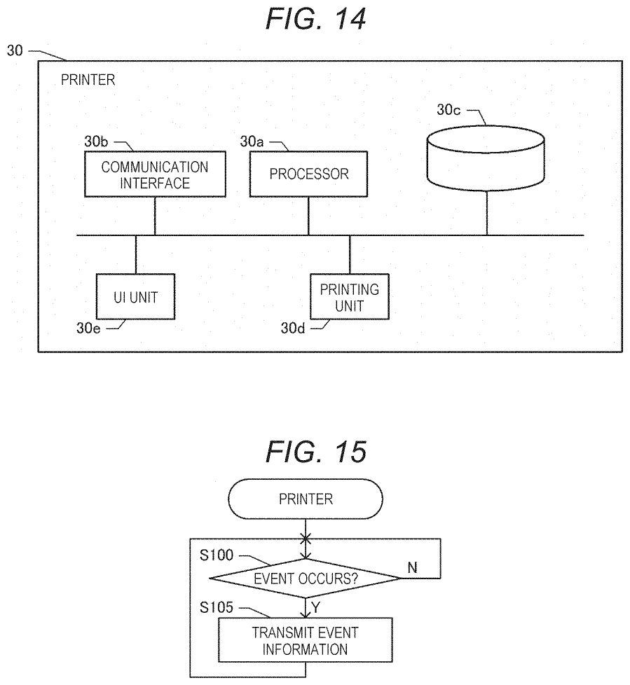

FIG. 14 is a block diagram showing a configuration of the printer 30. The printer 30 includes a processor 30a, a communication interface 30b, a nonvolatile memory 30c, a printing unit 30d, and a UI unit 30e. The processor 30a includes a CPU, a ROM, a RAM, and the like (not shown), and can execute various programs recorded in the nonvolatile memory 30c to control each unit of the printer 30.

The communication interface 30b is a device for communicating with an external device in accordance with various types of wired or wireless communication protocols. The printer 30 can communicate with the server 10 via the communication interface 30b. The communication interface 30b may include an interface for communicating with various types of removable memories attached to the printer 30.

The printing unit 30d is a unit that executes printing, and various types of printing methods such as an inkjet method and an electrophotographic method may be adopted. The printing unit 30d includes actuators, various types of devices, sensors, drive circuits, mechanical components, and the like for executing printing on various types of medium. The sensor includes a sensor that detects various types of detection targets that can change in the printer 30. The detection target is not limited, and examples thereof include a sensor that detects the remaining amount of medium, and a sensor that detects the remaining amount of ink for each color used for printing.

The UI unit 30e includes a touch panel display, various types of keys, switches, and the like. The touch panel display includes a display panel that displays various types of information, for example, the status of the printer 30 and the remaining amount of ink, and a touch detection panel superimposed on the display panel, and detects a touch operation by a human finger or the like. The processor 30a can acquire an operation content of the user via the UI unit 30e. Further, the processor 30a can display various types of information on the display of the UI unit 30e to notify the user of the information.

In the present embodiment, the plurality of printers 30 are installed in a facility owned by a printing company, and printing of the printers 30 can be implemented in parallel in response to a plurality of requests from a plurality of clients. The server 10 instructs the printer 30 to print the print target allocated to each printer 30 according to the request allocation information of the management data 10c2. At this time, the server 10 performs various types of image processing based on the document file 10c1 as the print target, and outputs print data indicating a content to be printed to the printer 30 via the communication interface 10b. The processor 30a of the printer 30 acquires the print data via the communication interface 30b, controls the printing unit 30d based on the print data, and implements printing. When the printing ends, the processor 30a outputs information indicating that the printing ends to the server 10 via the communication interface 30b. When the server 10 acquires the information via the communication interface 10b, the processor 10a identifies a print target in a next processing order of the print target for which printing is ended, and gives a print start instruction for the print target. At this time, the server 10 deletes the printed print target from the request allocation information of the management data 10c2. Further, the server 10 updates the step progress and the event information 10c3 included in the request information of the management data 10c2.

When an error occurs in the printer 30, the processor 30a identifies a type of the error based on the sensor (not shown) described above, and transmits the event identification information associated with the printer identification information via the communication interface 30b. The server 10 updates the printer status information of the management data 10c2 and the event information 10c3 based on the event identification information. When the status of the printer 30 changes or a trigger for updating the status occurs, the processor 30a transmits information indicating the status of the printer 30 via the communication interface 30b. The server 10 updates the printer status information of the management data 10c2 and the event information 10c3 based on the information.

### (2) Printer Monitoring Process:

Next, a printer monitoring process in which the server 10, the mobile device 20, and the printer 30 as described above cooperate to monitor an event that occurs in the printer 30 will be described.

### (2-1) Process in Printer:

First, a process in the printer 30 will be described. FIG. 15 is a flowchart showing a process implemented by the processor 30a when an event to be notified occurs in the printer 30. When the printer 30 is started, the processor 30a starts the process shown in FIG. 15, and monitors whether an event occurs (step S100). For example, the processor 30a monitors whether an event such as an error occurs based on an output of the sensor (not shown). In addition, the processor 30a monitors whether the step progresses based on a signal of a printing process. When it is determined that these events do not occur, the processor 30a repeats the process of step S100 at regular time intervals.

When it is determined in step S100 that an event occurs, the processor 30a transmits the event information (step S105). That is, the processor 30a adds the printer identification information indicating the printer 30 in which the event occurs to the event identification information indicating the event, associates a parameter indicating a content of the event and a date and time with the printer identification information and the event identification information, and transmits these pieces of information to the server 10. When step S105 is executed, processes of step S100 and subsequent steps are repeated. FIG. 15 is a process related to the transmission of the event information, and other processes, for example, the printing process can be executed in parallel.

### (2-2) Process in Server:

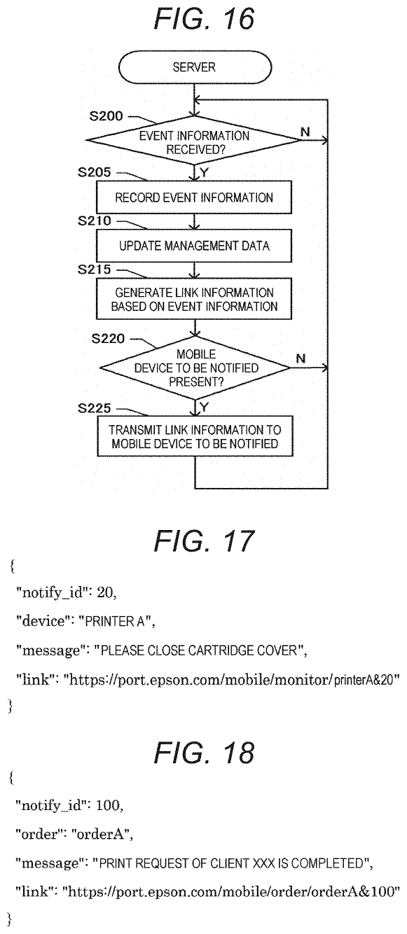

Next, a process in the server 10 will be described. FIG. 16 is a flowchart showing a process related to the printer monitoring and implemented by the processor 10a of the server 10. When the server 10 is started, the processor 10a starts the process shown in FIG. 16, and monitors whether the event information is received by the function of the communication unit 10a2 (step S200). In step S200, when it is determined that the event information is not received, the communication unit 10a2 repeats the process of step S200 at regular time intervals.

When it is determined in step S200 that the event information is received, the processor 10a records the event information by the function of the communication unit 10a2 (step S205). That is, the processor 10a adds the received event information to the event information 10c3 recorded in the nonvolatile memory 10c. Further, the processor 10a updates the management data 10c2 (the step progress of the request information, the print target of the request allocation information, the error identification information of the printer status information, the remaining amount of ink, and the like) based on the event information by the function of the communication unit 10a2 (step S210).

Next, the processor 10a generates the link information based on the event information by the function of the generation unit 10a1 (step S215). That is, the processor 10a identifies information to be added to the link information of the notification information DB 10c4 according to the event included in the event information. Specifically, when the event is an event in which information for each printer 30 is displayed on the related screen, the generation unit 10a1 refers to the event information 10c3 and acquires the printer identification information of the printer 30 in which the event occurs. Then, the generation unit 10a1 generates the link information in which the printer identification information and the event identification information are added to the link information indicated by the notification information DB 10c4.

For example, when the event identification information corresponds to an event related to a print error, the generation unit 10a1 generates the link information indicating the related screen that displays a status of the printer 30 in which the error occurs. More specifically, when the error in the event identification information 20 shown in FIG. 7 occurs, the generation unit 10a1 refers to the notification information DB 10c4 and acquires https://display application/mobile/monitor/which is a part of the link information. Further, the generation unit 10a1 adds the printer identification information and the event identification information included in the event information to the link information, and generates the link information, that is https://display application/mobile/monitor/printerA&20.

On the other hand, when the event is an event in which information for each request is displayed on the related screen, the generation unit 10a1 refers to the event information 10c3 to acquire the printer identification information of the printer 30 in which the event occurs, and refers to the request allocation information of the management data 10c2 to acquire the print target allocated to the printer of the printer identification information. Then, the generation unit 10a1 refers to the request information of the management data 10c2 to identify the request including the print target, and generates the link information in which the request identification information and the event identification information are added to the link information indicated by the notification information DB 10c4.

For example, when the event identification information corresponds to an event related to step progress in the printer, the generation unit 10a1 generates the link information indicating a related screen that displays the step progress. More specifically, when the step progress in the event identification information 100 shown in FIG. 7 occurs, the generation unit 10a1 refers to the notification information DB 10c4 and acquires https://display application/mobile/order/which is a part of the link information. Further, the generation unit 10a1 adds the request identification information and the event identification information to the link information, and generates the link information, that is https://display application/mobile/monitor/orderA&100.

When the link information is generated, the generation unit 10a1 refers to the notification information DB 10c4 to identify a notification message, adds the notification message and various types of identification information (the event identification information, the printer identification information, and the request identification information) to the link information, and generates information to be transmitted. FIG. 17 is a diagram showing information to be transmitted when the error of the event identification information 20 shown in FIG. 7 occurs, and FIG. 18 is a diagram showing information to be transmitted when the event of the event identification information 100 shown in FIG. 7 occurs.

Next, the communication unit 10a2 determines whether a mobile device to be notified is present (step S220). In the present embodiment, the mobile device 20 to be notified of an occurrence of an event is determined in advance, and an identification number thereof is recorded in the nonvolatile memory 10c. Therefore, the communication unit 10a2 refers to the nonvolatile memory 10c, and determines that the mobile device to be notified is present when the identification information of the mobile device 20 is recorded. When it is determined in step S220 that the mobile device to be notified is not present, the processor 10a repeats the processes of step S200 and subsequent steps.

On the other hand, when it is determined in step S220 that the mobile device to be notified is present, the communication unit 10a2 transmits the link information to the mobile device to be notified (step S225). That is, the communication unit 10a2 transmits the information generated in step S215 to the mobile device 20 indicated by the identification information via the communication interface 10b.

### (2-3) Process in Mobile Device:

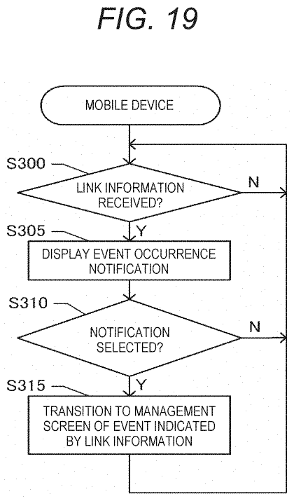

Next, a process in the mobile device 20 will be described. FIG. 19 is a flowchart showing a process related to the printer monitoring and implemented by the processor 20a of the mobile device 20. When the mobile device 20 is started, the processor 20a starts the process shown in FIG. 19, and monitors whether the link information transmitted from the server 10 is received by the function of the transition unit 20a1 (step S300). When it is determined in step S300 that the link information is not received, the processor 20a repeats the process of step S300 at regular time intervals.

When it is determined in step S300 that the link information is received, the processor 20a displays an event occurrence notification by the function of the transition unit 20a1 (step S305). That is, the transition unit 20a1 causes the display 20d to display a pop-up screen including the notification message included in the link information.

Next, the transition unit 20a1 determines whether the notification is selected (step S310). That is, when an operation of tapping the pop-up screen by the user is input by the input unit 20e, the transition unit 20a1 determines that the notification is selected. When it is determined in step S310 that the notification is not selected, the transition unit 20a1 repeats the processes of step S300 and subsequent steps. Even in this case, when the user performs an operation of cancelling the display of the notification (for example, a swipe operation on a portion including the pop-up screen) using the input unit 20e, the processor 20a performs a process not shown in FIG. 19 and deletes the display of the notification from the display 20d. On the other hand, when the operation of cancelling the display of the notification is not performed, the display of the notification is maintained, and when different link information is received in step S300 and the subsequent steps, a plurality of notifications are displayed. As a matter of course, this configuration is an example, and the operation of cancelling the display of the notification, a rule of the deletion of the notification by the operation, and the like may be other configurations.

When it is determined in step S315 that the notification is selected, the transition unit 20a1 causes a transition to a management screen of the event indicated by the link information (step S315). That is, the link information is transferred to the display application 20c1, and a screen indicated by the link information is displayed on the display 20d. Thereafter, the transition unit 20a1 repeats the processes of step S300 and the subsequent steps.

### (3) Other Embodiments:

The above embodiment is an example for implementing the present disclosure, and various embodiments other than the above embodiment can be adopted. For example, in the above-described embodiment, the server 10 and the mobile device 20 are constituted by different devices, but the server 10 and the mobile device 20 may be the same device or may be distributed to three or more devices. Further, an order of switchable processes may be changed, and a mode of the related screen, and modes of the management data 10c2, the event information 10c3, the notification information DB 10c4, and the like are examples, and different modes may be adopted.

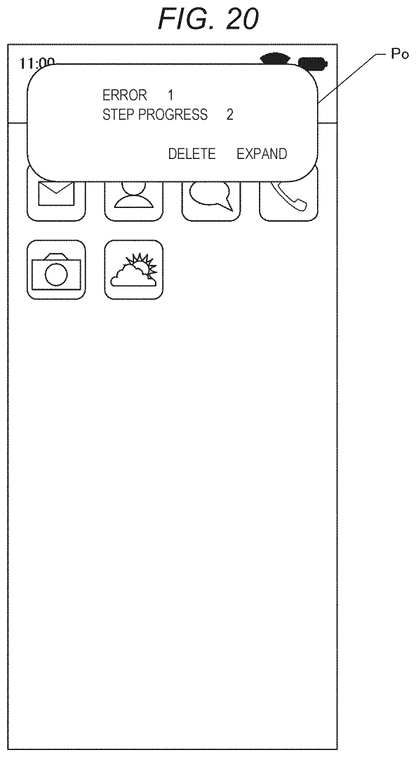

A mode of the notification implemented by the mobile device 20 when the event occurs is not limited to the above-described mode. For example, when a plurality of events coexist, the transition unit 20a1 may be configured to group the plurality of events and cause a display to display the grouped events. FIG. 20 is a diagram showing an example in which a plurality of events are grouped. This configuration can be implemented by changing the process of FIG. 19 in the same configuration as the above-described embodiment. That is, in step S305, when a displayed notification is present, the transition unit 20a1 groups the displayed notification and a newly received notification, and causes the display 20d to display the displayed notification and the newly received notification as the pop-up screen Po.

A display mode in the case of grouping is not particularly limited, and in the example shown in FIG. 20, types of events that occur (error, step progress, and the like) and the number of the events are displayed. According to this configuration, when a plurality of events occur, the user can easily grasp contents of the events that occur.

In the example shown in FIG. 20, texts such as delete and expand are displayed in a lower portion of the pop-up screen Po of the grouped notifications. The text of delete is provided to instruct deletion of the notification displayed in the pop-up screen Po. When the user taps the text of delete, the transition unit 20a1 deletes the pop-up screen Po from the display 20d.

The text of expand is provided to instruct to cause a plurality of grouped events to be individually displayed. When the user taps the text of expand, the transition unit 20a1 considers that an expansion instruction of the grouped events is received. In this case, the transition unit 20a1 expands and displays the plurality of events included in the group. Then, the transition unit 20a1 receives a selection for each event after the expansion.

In the example shown in FIG. 20, the transition unit 20a1 causes, for example, the pop-up screen Po for notifying a total of three occurrences including one error and two pieces of step progress to be displayed. When any one of the pop-up screens Po is tapped, the transition unit 20a1 considers that a selection of the event notified on the tapped screen is received. When the selection is received, the transition unit 20a1 transfers the link information in the received event to the display application 20c1, and causes the screen displayed by the display application 20c1 to transition to a related screen indicated by the link information. According to the above configuration, the user can clearly instruct an event whose details are to be checked.

Further, direct transition of a screen may be performed when the grouped events are selected. For example, when the grouped events are selected, the transition unit 20a1 may cause the screen displayed by the display application 20c1 to be transitioned to a related screen indicated by the link information corresponding to a latest event included in the group. More specifically, when an order of the occurrences of the three events included in the pop-up screen Po shown in FIG. 20 is the step progress, the step progress, and the error, the error is the latest event. In this case, when the user taps a position different from the delete or expand, for example, texts of the error or the step progress, the transition unit 20a1 causes a direct transition to the detailed screen (for example, FIG. 12) of the printer 30 in which the error occurs, based on the link information of the error that is the latest event. According to this configuration, the user can always grasp details of a latest event based on a screen transitioned by the selection of the user.

Further, the transitioned screen displayed when the grouped events are selected may be a screen corresponding to the group. For example, a configuration in which events of a same type are grouped (events of different types are not grouped) is considered. In such a configuration, when the grouped events are selected, the transition unit 20a1 may cause the screen displayed by the display application 20c1 to be transitioned to a related screen corresponding to the group.

For example, it can be considered that the error is an event of the same type and the step progress is an event of the same type. Therefore, when a plurality of errors occur in the printer 30, the plurality of errors are grouped and notified by one pop-up screen Po, which is one notification. Similarly, when there are step progresses related to a plurality of print targets in the printer 30, the plurality of step progress are grouped and notified by one pop-up screen Po which is one notification. In this case, details of the respective events are different screens, but an upper layer thereof is a common screen.

For example, the detail screen as shown in FIG. 12, which is displayed when an error occurs in the printer 30, shows the details of the individual printer 30 in which the error occurs, but since FIG. 10, which is the Printers screen of the upper layer thereof, is the list of printers 30, the printer 30 in which the error occurs is also displayed on this screen. It is also possible to transition from this screen to a screen showing the details of the printer 30 in which an error occurs. Therefore, as long as the Printers screen is defined as a related screen corresponding to a group, and is caused to be transitioned to the upper layer by selecting a notification in which a plurality of errors are grouped, it is possible to display a screen that can be easily transitioned to any of the grouped events.

Such a transition to the upper layer can be implemented by various modes, but in the present embodiment, such a transition is implemented by transitioning to the related screen of the hierarchy common to the link information corresponding to the plurality of events included in the group. Specifically, in the present embodiment, the screen has a hierarchical structure, and in the link information in the URL format, a lower layer screen can be specified by adding a portion delimited by /, and an upper layer screen can be specified by deleting the portion delimited by /.

Therefore, for example, if the printerA&20 is deleted from https://display application/mobile/monitor/printerA&20, which is the link information specifying a screen to be directly transitioned when an error occurs in the printer A, a screen that is an upper layer thereof and displays the list of printers 30 including the printer 30 in which the error occurs can be specified. Therefore, when the grouped events are selected, the transition unit 20a1 causes a transition to a screen specified in a state in which the event identification information or the like is not added to the link information (https://display application/mobile/monitor/) shown in FIG. 7. According to this configuration, it is possible to easily cause a transition to a screen corresponding to a plurality of events included in a group. The same applies to a case in which the grouped notification is the step progress, and when the grouped notification is selected, the transition unit 20a1 may cause a transition to a screen specified in the state in which the event identification information or the like is not added to the link information (https://display application/mobile/order/) shown in FIG. 7.

The event that occurs in the printer may be any event as long as the event is notified to the user of the mobile device, and any event that occurs during an operation of the printer may be the event to be notified. Therefore, the present disclosure is not limited to the example of the above-described embodiment. Examples of the event include changes in an operating state of the printer, occurrence status of an error in the printer, information (such as a person in charge) allocated to the printer, status of the printer, and predetermined progress and the like of the printer. As a matter of course, even if there is no change in the operating state or the like, a current state may be displayable on the mobile device.

The server has a function of collecting event information and transmitting the collected event information to a mobile device, and as a matter of course, the server may have other functions. For example, the server can communicate with a printer and a mobile device, collect various types of information related to the printer, record the information in a recording medium, and transmit any information to the mobile device.

The mobile device only needs to be capable of executing a display application for displaying a related screen including event information on the display, and as a matter of course, may be capable of executing any other applications. In addition, various types of functions may be implemented by the operating system.

The related screen including the event information may be a screen on which the event information is displayed in any mode, and is not limited to the screen of the above-described embodiment. That is, each piece of the event information of the plurality of events includes at least one type of related screen including the event information. The user can cause a desired related screen to be displayed by transitioning the screen once or more as necessary by an operation under the execution of the display application. The direct transition may be a process of causing the screen of the display application to transition to the related screen of each event in accordance with the selection of the event without passing through a plurality of times of screen transitions.

The event information may indicate an event that occurs in the printer, and may be information directly or indirectly indicating the event. The mode of the event information is not limited to the mode described by the identification information and the parameter as in the above-described embodiment. The link information may be information for displaying a related screen of an event in the display application. Therefore, the present disclosure is not limited to a deep link in which a hierarchical structure corresponding to the hierarchical structure of the screen is described as in the above-described embodiment, and may be information of various types of modes for displaying the related screen.

When an event that occurs in the printer is displayed on the display in a selectable manner, a notification indicating an occurrence of the event or a notification that allows the user to determine whether to cause a direct transition to the related screen may be performed. Therefore, a mode of the notification is not limited to the mode in which a structure of the notification provided by the operating system is used as in the above-described embodiment. For example, a mode in which the notification is performed by the function of the display application may be implemented.

The transition unit only needs to be capable of causing the screen displayed by the display application to be transitioned to the related screen indicated by the link information according to the selection of the event. That is, an operation for reaching the related screen achieved by the user performing an operation for switching the screen through the user interface provided by the display application is omitted, and the screen may be switched to the related screen in accordance with the selection of the event. As such a mode, various modes may be assumed, for example, in a configuration in which a screen wider than a region displayed on a display of a mobile device is drawn, an operation such as scrolling is omitted, and the screen is switched so that a screen including event information is displayed on the display.

Further, the present disclosure can also be applied as a program executed by a computer or a method. In addition, the system, program, and method as described above may be implemented by a single device or may be implemented by using components included in a plurality of devices, and includes various types of aspects. In addition, it is possible to appropriately change the configuration such that a part of the configuration is software and a part of the configuration is hardware. Further, the present disclosure is also applicable to a recording medium of a program that controls the system. As a matter of course, the recording medium of the program may be a magnetic recording medium, a semiconductor memory, or the like, and any recording medium to be developed in the future can be considered in the same manner.

What is claimed is:

1. A printer monitoring system comprising:
a server configured to collect event information indicating an event that occurs in a printer; and
a mobile device configured to execute a display application that causes a display to display a related screen including the event information, wherein
the server includes a generation unit configured to generate link information for directly transitioning a screen displayed by the display application to the related screen corresponding to the event information, and a communication unit configured to transmit the event information received from the printer and the link information to the mobile device, and
the mobile device includes a transition unit configured to display the event that occurs in the printer on the display in a selectable manner, and cause a screen displayed by the display application to be transitioned to the related screen indicated by the link information when the event is selected.

2. The printer monitoring system according to claim 1, wherein
the communication unit is configured to receive, from the printer, the event information including event identification information which is identification information corresponding to the event that occurs in the printer, and
the generation unit is configured to generate the link information indicating the related screen corresponding to the event identification information.

3. The printer monitoring system according to claim 2, wherein
the generation unit is configured to
generate, when the event identification information corresponds to the event related to a print error, the link information indicating the related screen that displays a status of the printer in which the error occurs, and
generate, when the event identification information corresponds to the event related to step progress in the printer, the link information indicating the related screen that displays the step progress.

4. The printer monitoring system according to claim 1, wherein
the transition unit is configured to group a plurality of the events and cause the display to display the grouped events.

5. The printer monitoring system according to claim 4, wherein
the transition unit is configured to, when an instruction to expand the grouped events is received, expand and display a plurality of the events included in a group, receive a selection, and cause a screen displayed by the display application to be transitioned to the related screen indicated by the link information corresponding to the selected event.

6. The printer monitoring system according to claim 4, wherein
the transition unit is configured to, when the grouped events are selected, cause a screen displayed by the display application to be transitioned to the related screen indicated by the link information corresponding to a latest event included in a group.

7. The printer monitoring system according to claim 4, wherein
the transition unit is configured to, when the grouped events are selected, cause a screen displayed by the display application to be transitioned to the related screen corresponding to a group.

8. The printer monitoring system according to claim 7, wherein
the related screen has a hierarchical structure in which an upper layer screen is configured to be transitioned to a lower layer screen,
the link information indicates a hierarchy of the related screen corresponding to the event information, and
the transition unit is configured to, when the grouped events are selected, cause a screen displayed by the display application to be transitioned to the related screen of a hierarchy common to the link information corresponding to a plurality of the events included in the group.

9. A printer monitoring method executed by a server configured to collect event information indicating an event that occurs in a printer, and a mobile device configured to execute a display application that causes a display to display a related screen including the event information, wherein
the server executes a generation step of generating link information for directly transitioning a screen displayed by the display application to the related screen corresponding to the event information, and a communication step of transmitting the event information received from the printer and the link information to the mobile device, and
the mobile device executes a transition step of displaying the event that occurs in the printer on the display in a selectable manner, and causing a screen displayed by the display application to be transitioned to the related screen indicated by the link information when the event is selected.

10. A non-transitory computer-readable storage medium storing a printer monitoring program, the printer monitoring program causing:
a server configured to collect event information indicating an event that occurs in a printer to function as a generation unit configured to generate link information for directly transitioning a screen displayed by a display application to a related screen corresponding to the event information, and as a communication unit configured to transmit the event information received from the printer and the link information to a mobile device; and
the mobile device configured to execute the display application for displaying the related screen including the event information on a display to function as a transition unit configured to display the event that occurs in the printer on the display in a selectable manner, and cause a screen displayed by the display application to be transitioned to the related screen indicated by the link information when the event is selected.
